(19) United States
(12) Patent Application Publication
(10) Pub. No.: US 2021/0209069 A1
(43) Pub. Date: Jul. 8, 2021

(54) METHOD, DEVICE, AND SYSTEM FOR PROCESSING DISTRIBUTED DATA, AND MACHINE READABLE MEDIUM

(71) Applicant: Siemens Aktiengesellschaft, Muenchen (DE)

(72) Inventor: Yi MAO, Beijing (CN)

(73) Assignee: Siemens Aktiengesellschaft, Muenchen (DE)

(21) Appl. No.: 17/267,897

(22) PCT Filed: Aug. 17, 2018
(86) PCT No.: PCT/CN2018/101063

§ 371 Date: Feb. 11, 2021

(51) Int. Cl. G06F 16/182

(52) U.S. Cl. CPC G06F 16/1834

(57) ABSTRACT

A method includes: storing, on an InterPlanetary File System, input data and a corresponding map program and reduce program; selecting at least two operation nodes from at least two computation nodes; controlling each operation node to download at least one of the map program and the reduce program, and controlling the operation node to download the input data; using the at least two operation nodes to subject the input data to mapreduce processing via the map program and the reduce program, to obtain at least two result data corresponding to the input data; storing the at least two result data in the IPFS, and separately obtaining first storage address information corresponding to each result data. A Hash value is obtained, of output data corresponding to the input data according to at least two items of second storage address information corresponding to the at least two result data.

### PRIORITY STATEMENT

This application is the national phase under 35 U.S.C. § 371 of PCT International Application No. PCT/CN2018/101063 which has an International filing date of Aug. 17, 2018, which designated the United States of America, the entire contents of which are hereby incorporated herein by reference.

### FIELD

Embodiments of the present invention generally relate to the technical field of data processing, in particular to a distributed data processing method, device and system, and a machine readable medium.

### BACKGROUND

Distributed data processing is a technical approach for processing data using distributed computing technology, the procedure for data processing specifically being as follows: a large quantity of input data is divided into multiple data blocks, which are then distributed to multiple computation nodes in a computer network to undergo parallel processing, and finally the computing data of all of the computation nodes are integrated and organized to obtain a computing result, in order to improve the efficiency of data processing.

At present, when distributed data processing is performed, the input data to be processed is generally stored on a Hadoop Distributed File System (HDFS), and then each of the computation nodes in the computing network reads the input data to be processed from the HDFS and perform distributed data processing.

With regard to methods of performing distributed data processing at the present time, when each of the computation nodes in the computing network reads the input data to be processed from the HDFS, this needs to be done via a management node (Name Node) of the HDFS in a unified manner; if the Name Node develops a fault, this will result in all of the computation nodes being unable to read the input data to be processed from the HDFS, so that distributed data processing is unable to proceed normally. Thus, existing distributed data processing has poor usability.

### SUMMARY

In view of the above, the distributed data processing method, device and system and the machine readable medium provided in the present invention can improve the usability of distributed data processing.

In a first aspect, an embodiment of the present invention provides a distributed data processing method, in which input data to be processed and a corresponding map program and reduce program are stored on an IPFS, then at least two operation nodes are selected from at least two predetermined computation nodes, each operation node is controlled to download at least one of the map program and reduce program from the IPFS, and the operation node that has downloaded the map program is controlled to download the input data from the IPFS, then the operation nodes are used to subject the input data to mapreduce processing via the map program and reduce program, to obtain at least two result data corresponding to the input data, then the at least two result data obtained are stored on the IPFS, and first storage address information corresponding to each result data is obtained, and finally a Hash value of output data corresponding to the input data is obtained according to each item of first storage address information.

In a second aspect, an embodiment of the present invention further provides a distributed data processing device, comprising:

a data uploading module, for storing, on an InterPlanetary File System IPFS, input data to be processed and a corresponding map program and reduce program;

a node selection module, for selecting at least two operation nodes from at least two predetermined computation nodes;

a data distribution module, for controlling each operation node to download from the IPFS at least one of the map program and the reduce program stored by the data uploading module, and controlling the operation node that has downloaded the map program to download from the IPFS the input data stored by the data uploading module;

a processing control module, for using the at least two operation nodes selected by the node selection module to subject the input data to mapreduce processing via the map program and the reduce program downloaded under the control of the data distribution module, to obtain at least two result data corresponding to the input data;

a data storage module, for storing in the IPFS the at least two result data obtained by the processing control module, and separately obtaining first storage address information corresponding to each result data;

a data integration module, for obtaining second storage address information of output data corresponding to the input data according to the at least two items of first storage address information corresponding to the at least two result data and acquired by the data storage module.

In a third aspect, an embodiment of the present invention further provides a distributed data processing device, comprising:

at least one memory; and

at least one processor;

the at least one memory being configured to store a machine readable program;

the at least one processor being configured to call the machine readable program, to execute the method provided in the first aspect or any embodiment of the first aspect.

In a fourth aspect, an embodiment of the present invention further provides a distributed data processing system, comprising: any distributed data processing device provided in the second aspect, any embodiment of the second aspect, the third aspect or any embodiment of the third aspect, an IPFS and at least two computation nodes;

the IPFS being configured to store input data, a map program and a reduce program uploaded by the distributed data processing device;

the computation nodes being configured to: be selected by the distributed data processing device and, when selected as operation nodes, download at least one of the map program and the reduce program from the IPFS under the control of the distributed data processing device, download the input data from the IPFS after downloading the map program, and subject the input data to mapreduce processing via the map program and the reduce program under the control of the distributed data processing device.

In a fifth aspect, an embodiment of the present invention further provides a machine readable medium, having stored thereon a computer instruction which, when executed by a processor, causes the processor to execute the method provided in the first aspect above or any possible embodiment of the first aspect.

### BRIEF DESCRIPTION OF THE DRAWINGS

FIG. 1 is a schematic diagram of a distributed data processing system provided in an embodiment of the present invention.

FIG. 2 is a schematic diagram of another distributed data processing system provided in an embodiment of the present invention.

FIG. 3 is a schematic diagram of another distributed data processing system provided in an embodiment of the present invention.

FIG. 4 is a flow chart of a distributed data processing method provided in an embodiment of the present invention.

FIG. 5 is a flow chart of an operation node selection method provided in an embodiment of the present invention.

FIG. 6 is a flow chart of a method for selecting map nodes and reduce nodes as provided in an embodiment of the present invention.

FIG. 7 is a flow chart of a method for controlling map nodes and reduce nodes to perform mapreduce processing as provided in an embodiment of the present invention.

FIG. 8 is a schematic diagram of a distributed data processing device provided in an embodiment of the present invention.

FIG. 9 is a schematic diagram of a node selection module provided in an embodiment of the present invention.

FIG. 10 is a schematic diagram of another distributed data processing device provided in an embodiment of the present invention.

FIG. 11 is a schematic diagram of a processing control module provided in an embodiment of the present invention.

FIG. 12 is a schematic diagram of another distributed data processing device provided in an embodiment of the present invention.

### KEY TO REFERENCE LABELS

10: IPFS
20: operation node
30: distributed data processing device
201: map node
202: reduce node
301: data uploading module
302: node selection module
303: data distribution module
304: processing control module
305: data storage module
306: data integration module
307: node allocation module
3021: node identifier acquisition unit
3022: Hash operation unit
3023: node selection unit
3041: map control node
3042: reduce control node
401: store input data, map program and reduce program in IPFS
402: select at least two operation nodes from at least two computation nodes
403: control operation nodes to download input data, map program and reduce program from IPFS
404: use operation nodes to subject input data to mapreduce processing to obtain result data
405: store result data in IPFS and obtain first storage address information
406: obtain output second storage address information corresponding to input data according to each item of first storage address information
501: acquire node identifiers of computation nodes
502: subject node identifiers to Hash operation to obtain corresponding node Hash values
503: select operation nodes from computation nodes according to node Hash values
601: subject node Hash values to annular sequencing
602: subject input data to Hash operation to obtain positioning Hash value
603: determine position of positioning Hash value in annularly sequenced node Hash values
604: determine target node Hash values according to position of positioning Hash value
605: determine computation nodes corresponding to target node Hash values to be operation nodes
701: use map node to subject input data to map processing to obtain intermediate result
702: use reduce node to subject intermediate result to reduce processing to obtain result data

### DETAILED DESCRIPTION OF THE EXAMPLE EMBODIMENTS

In a first aspect, an embodiment of the present invention provides a distributed data processing method, in which input data to be processed and a corresponding map program and reduce program are stored on an IPFS, then at least two operation nodes are selected from at least two predetermined computation nodes, each operation node is controlled to download at least one of the map program and reduce program from the IPFS, and the operation node that has downloaded the map program is controlled to download the input data from the IPFS, then the operation nodes are used to subject the input data to mapreduce processing via the map program and reduce program, to obtain at least two result data corresponding to the input data, then the at least two result data obtained are stored on the IPFS, and first storage address information corresponding to each result data is obtained, and finally a Hash value of output data corresponding to the input data is obtained according to each item of first storage address information.

Since the input data, map program and reduce program are all stored on the IPFS, based on a point-to-point transfer protocol of the operating IPFS, there is no need to rely on a specific node in the IPFS when the operation nodes download the input data, map program and reduce program from the IPFS; a fault in a portion of the nodes of the IPFS will not affect normal downloading of the input data, map program and reduce program by the operation nodes, hence the distributed data processing procedure will not be unable to proceed normally due to a single-point fault in the IPFS, thus the usability of distributed data processing can be improved.

Optionally, when selecting the operation nodes from the computation nodes, it is possible to acquire a node identifier of each computation node, then subject the node identifiers to a Hash operation according to a preset Hash function, to acquire a node Hash value corresponding to each computation node, and then select at least two computation nodes as the operation nodes according to the Hash value corresponding to each of the computation nodes.

By subjecting the node identifiers of the computation nodes to a Hash operation to obtain Hash values corresponding to the computation nodes and then selecting the operation nodes from the computation nodes according to the node Hash values corresponding to the computation nodes, the randomness of the operation nodes selected is increased, thus reducing the risk that the operation nodes selected will be maliciously hijacked, and it is thereby possible to improve the security of distributed data processing.

Optionally, after controlling the operation nodes to download at least one of the map program or reduce program from the IPFS, for each operation node that has downloaded the map program, the operation node can be controlled to download all or a portion of the data included in the input data from the IPFS according to the type of the map program downloaded by the operation node.

For the operation node that has downloaded the map program, the operation node can be controlled to download all or a portion of the data included in the input data from the IPFS according to the type of the map program downloaded by the operation node, i.e. the operation node can be controlled to download the data that it needs to process, and input data that the operation node does not need to process need not be downloaded; this can reduce the pressure on the IPFS due to data reading, and at the same time can shorten the time needed for the operation node to download the input data, thus increasing the efficiency of distributed data processing.

Optionally, after selecting the operation nodes, the numbers of map nodes and reduce nodes required can be determined according to a preset configuration parameter or according to the data quantity of the input data, and then a corresponding number of the operation nodes are selected as map nodes, and a corresponding number of the operation nodes are selected as reduce nodes. Correspondingly, after determining the map nodes and reduce nodes, each map node is controlled to download the map program and input data from the IPFS, and each reduce node is controlled to download the reduce program from the IPFS.

The numbers of map nodes and reduce nodes can be defined by a user via a configuration parameter, or determined automatically by a system according to the data quantity of the input data; it is thereby possible to meet the individual needs of different users, helping to increase the applicability of the distributed data processing method.

Optionally, after determining the map nodes and reduce nodes, each map node can be used separately to subject the downloaded input data to map processing via the downloaded map program, an intermediate result obtained through map processing is stored on an internal memory of the map node or on the IPFS, and then each reduce node is used separately to read at least one intermediate result from the internal memory of the map node or from the IPFS to undergo reduce processing, to obtain result data corresponding to each reduce node.

The intermediate result obtained through map processing by the map node may be stored in the internal memory thereof, or stored in the IPFS; the specific storage position of the intermediate result can be determined according to the data quantity of the intermediate result. If the data quantity of the intermediate result is small, the intermediate result is stored in the internal memory of the map node, to save the time needed to transfer the intermediate result, and increase the efficiency of distributed data processing; if the data quantity of the intermediate result is large, the intermediate result is stored in the IPFS, ensuring that the map node has enough internal memory for normal operation.

Optionally, when storing the result data in the IPFS, for each reduce node, first of all the reduce node is controlled to store the result data obtained through reduce processing in a local disk thereof, and then the reduce node is controlled to upload the result data stored in the local disk thereof to the IPFS via a data transfer program pre-deployed on the reduce node.

Since the reduce node cannot upload the result data directly to the IPFS via the reduce program, a data transfer program is pre-deployed on the reduce node; after obtaining the result data, the reduce node first stores the result data in a local disk, and then uploads the result data stored in the local disk to the IPFS via the data transfer program, thus ensuring that the result data obtained by each reduce node can be successfully uploaded to the IPFS, and making it convenient for the user to acquire output data of distributed data processing from the IPFS.

In a second aspect, an embodiment of the present invention further provides a distributed data processing device, comprising:

a data uploading module, for storing, on an InterPlanetary File System IPFS, input data to be processed and a corresponding map program and reduce program;

a node selection module, for selecting at least two operation nodes from at least two predetermined computation nodes;

a data distribution module, for controlling each operation node to download from the IPFS at least one of the map program and the reduce program stored by the data uploading module, and controlling the operation node that has downloaded the map program to download from the IPFS the input data stored by the data uploading module;

a processing control module, for using the at least two operation nodes selected by the node selection module to subject the input data to mapreduce processing via the map program and the reduce program downloaded under the control of the data distribution module, to obtain at least two result data corresponding to the input data;

a data storage module, for storing in the IPFS the at least two result data obtained by the processing control module, and separately obtaining first storage address information corresponding to each result data;

a data integration module, for obtaining second storage address information of output data corresponding to the input data according to the at least two items of first storage address information corresponding to the at least two result data and acquired by the data storage module.

The data uploading module stores the input data, map program and reduce program on the IPFS, the data distribution module controls the operation nodes selected by the node selection module to read the input data, map program and reduce program from the IPFS, the processing control module uses the operation nodes to subject the downloaded input data to mapreduce processing via the downloaded map program and reduce program, the data storage module stores on the IPFS at least two result data obtained through mapreduce processing by the processing control module, and obtains first storage address information corresponding to each result data, and the data integration module obtains second storage address information of output data corresponding to the input data according to each item of first storage address information obtained by the data storage module. Since the data uploading module stores the input data, map program and reduce program on the IPFS, based on the point-to-point data transfer protocol of the IPFS, the procedure of the data distribution module controlling the operation nodes to download the input data, map program and reduce program from the IPFS will not be unable to proceed due to a fault in a particular node of the IPFS, and it is thereby possible to improve the usability of distributed data processing.

Optionally, the node selection module comprises:

a node identifier acquisition unit, for acquiring a node identifier of each of the at least two predetermined computation nodes;

a Hash operation unit, for separately subjecting the node identifier corresponding to each the computation node and acquired by the node identifier acquisition unit to a Hash operation according to a preset Hash function, to obtain a corresponding node Hash value;

a node selection unit, for selecting as the operation nodes at least two of the at least two computation nodes according to the node Hash value corresponding to each of the computation nodes and obtained by the Hash operation unit.

The node identifier acquisition unit can acquire a node identifier of each computation node, the Hash operation unit can subject the node identifier of each computation node to a Hash operation, to obtain a node Hash value corresponding to each computation node, and the node selection unit can select operation nodes from the computation nodes according to the node Hash values corresponding to the computation nodes. Computation nodes are selected as operation nodes according to the Hash values of the node identifiers of the computation nodes, ensuring that the operation nodes selected have a high degree of randomness, reducing the risk to distributed data processing caused by malicious hijacking of a portion of the computation nodes, and thus helping to increase the security of distributed data processing.

Optionally, the data distribution module is configured, for each the operation node, to control the operation node to download all or a portion of the data included in the input data from the IPFS according to the type of the map program downloaded by the operation node.

Since the data distribution module can control the operation node to download all or a portion of the data included in the input data from the IPFS according to the type of the map program downloaded by the operation node, the operation node only downloads the portion of input data that it needs to subject to map processing; this can shorten the time needed for the operation node to download the input data, and can thereby improve the efficiency of distributed data processing.

Optionally, the distributed data processing device further comprises: a node allocation module, for selecting as map nodes at least two of the at least two operation nodes selected by the node selection module, and selecting as a reduce node at least one of the at least two operation nodes selected by the node selection module, wherein the numbers of the map nodes and the reduce node are determined according to a preset configuration parameter or determined according to the data quantity of the input data; the data distribution module being configured to control each map node selected by the node allocation module to download the map program and the input data from the IPFS, and control each reduce node selected by the node allocation module to download the reduce program from the IPFS.

When selecting the map nodes and reduce node from the operation nodes, the node allocation module can determine the number of the map nodes and the number of the reduce node according to a configuration parameter pre-defined by the user, but can also determine the number of the map nodes and the number of the reduce node according to the data quantity of the input data; it is thereby possible to meet individual needs of different users, and increase the users' satisfaction with distributed data processing.

Optionally, the processing control module comprises:

a map control unit, for using each map node separately to subject the downloaded input data to map processing via the downloaded map program, and storing an intermediate result obtained through map processing by the map node in an internal memory of the map node or in the IPFS;

a reduce control unit, for using each reduce node separately to read at least one intermediate result from the internal memory of at least one map node or from the IPFS, and subjecting the read intermediate result to reduce processing via the downloaded reduce program, to obtain the result data corresponding to the reduce node.

After controlling the map node to perform map processing to obtain the intermediate result, the map control unit can control the map node to store the intermediate result in the internal memory of the map node or in the IPFS; specifically, when the data quantity of the intermediate result is small, the map node is controlled to store the intermediate result in the internal memory of the map node, thus saving the time needed to transfer the intermediate result, and increasing the efficiency of distributed data processing; when the data quantity of the intermediate result is large, the map node is controlled to store the intermediate result on the IPFS, ensuring that the map node has enough internal memory for normal operation.

Optionally, the data storage module is configured, for each reduce node, to control the reduce node to store the result data obtained through reduce processing in a local disk of the reduce node, and upload the result data stored in the local disk to the IPFS via a data transfer program pre-deployed on the reduce node.

The data storage control module controls the reduce node to store the result data obtained through reduce processing in a local disk of the reduce node, and then controls the reduce node to upload the result data stored in the local disk thereof to the IPFS via a pre-deployed data transfer program, thus ensuring that the result data can be successfully uploaded to the IPFS for viewing by the user.

In a third aspect, an embodiment of the present invention further provides a distributed data processing device, comprising:

at least one memory; and

at least one processor;

the at least one memory being configured to store a machine readable program;

the at least one processor being configured to call the machine readable program, to execute the method provided in the first aspect or any embodiment of the first aspect.

The machine readable program is stored in the memory, and the processor can execute the method provided in the first aspect above or any embodiment of the first aspect by calling the machine readable program stored in the memory; input data to be processed and a corresponding map program and reduce program are stored on an IPFS, then selected operation nodes are controlled to download the input data, map program and reduce program from the IPFS, and the operation nodes are controlled to subject the downloaded input data to mapreduce processing via the downloaded map program and reduce program, multiple result data obtained through mapreduce processing are stored on the IPFS, and second storage address information corresponding to the input data is obtained according to first storage address information corresponding to each of the result data. Since the input data, map program and reduce program are all stored on the IPFS, based on the point-to-point data transfer protocol of the IPFS, the procedure of the operation nodes downloading the input data, map program and reduce program from the IPFS will not be unable to proceed due to a fault in a particular node of the IPFS, and it is thereby possible to improve the usability of distributed data processing.

In a fourth aspect, an embodiment of the present invention further provides a distributed data processing system, comprising: any distributed data processing device provided in the second aspect, any embodiment of the second aspect, the third aspect or any embodiment of the third aspect, an IPFS and at least two computation nodes;

the IPFS being configured to store input data, a map program and a reduce program uploaded by the distributed data processing device;

the computation nodes being configured to: be selected by the distributed data processing device and, when selected as operation nodes, download at least one of the map program and the reduce program from the IPFS under the control of the distributed data processing device, download the input data from the IPFS after downloading the map program, and subject the input data to mapreduce processing via the map program and the reduce program under the control of the distributed data processing device.

The distributed data processing device can store the input data to be processed and the corresponding map program and reduce program on the IPFS, and the computation nodes that are selected as the operation nodes by the distributed data processing device can read the input data, map program and reduce program from the IPFS; based on the point-to-point data transfer protocol of the IPFS, the procedure of the operation nodes downloading the input data, map program and reduce program from the IPFS will not be unable to proceed due to a fault in a particular node of the IPFS, and it is thereby possible to improve the usability of distributed data processing.

In a fifth aspect, an embodiment of the present invention further provides a machine readable medium, having stored thereon a computer instruction which, when executed by a processor, causes the processor to execute the method provided in the first aspect above or any possible embodiment of the first aspect.

The machine readable medium has a computer instruction stored thereon, and when the computer instruction is executed by the processor, the processor will execute the distributed data processing method provided in the first aspect above and any possible embodiment of the first aspect; upload data to be processed and a corresponding map program and reduce program are stored on an IPFS, selected operation nodes are controlled to download the input data, map program and reduce program from the IPFS to undergo mapreduce processing, result data obtained through mapreduce processing are stored on the IPFS, and then second storage address information of output data corresponding to the input data is obtained according to first storage address information corresponding to each of the result data. The input data, map program and reduce program are stored on the IPFS; based on the point-to-point data transfer protocol of the IPFS, the procedure of the operation nodes downloading the input data, map program and reduce program from the IPFS will not be unable to proceed due to a fault in a particular node of the IPFS, and it is thereby possible to improve the usability of distributed data processing.

As stated above, when distributed data processing is performed at the present time, all of the computation nodes in the computing network must read the input data from the HDFS via the Name Node of the HDFS; if the Name Node of the HDFS develops a fault, this will result in the computation nodes being unable to read the input data from the HDFS, and the distributed data processing procedure will be unable to continue due to the lack of data input. Although the HDFS is a distributed data storage system, data must be read from and written to the HDFS via the Name Node thereof, so the Name Node of the HDFS has a high workload and easily develops faults; if the Name Node of the HDFS develops a fault, the reading of data from the HDFS will not be able to continue, thus distributed data processing based on the reading of input data from the HDFS has poor usability.

In the embodiments of the present invention, input data that is to undergo distributed data processing, as well as a map program and a reduce program used in the course of distributed data processing, are all stored on an InterPlanetary File System (IPFS). Based on the point-to-point transfer protocol of the IPFS, even if a portion of the nodes of the IPFS develop a fault, this will not affect the ability of each computation node to read the input data, map program and reduce program from the IPFS to perform distributed data processing, hence the distributed data processing procedure will not be unable to proceed normally due to inability to read the input data; thus, the usability of distributed data processing can be improved.

The method and equipment provided in embodiments of the present invention are explained in detail below in conjunction with the drawings.

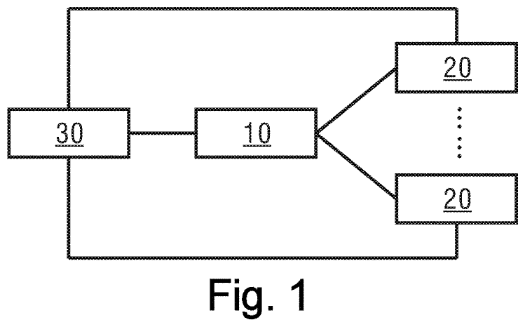

As shown in FIG. 1, an embodiment of the present invention provides a distributed data processing system, comprising: an IPFS 10, a distributed data processing device 30 and at least two computation nodes.

The IPFS 10 is configured to store input data, a map program and a reduce program uploaded by the distributed data processing device 30.

The distributed data processing device 30 is configured to select at least two operation nodes 20 from the at least two computation nodes, separately control each operation node 20 to download a portion or all of the map program and reduce program from the IPFS 10, and control the operation node 20 that has downloaded the map program to download the input data from the IPFS 10.

The at least two operation nodes 20 are configured to subject the downloaded input data to mapreduce processing via the downloaded map program and reduce program, under the control of the distributed data processing device 30, to obtain at least two result data corresponding to the input data.

The distributed data processing device 30 is further configured to store the obtained at least two result data in the IPFS 10, obtain first storage address information corresponding to each result data, and obtain second storage address information of output data corresponding to the input data according to the acquired at least two items of first storage address information corresponding to the at least two result data.

In the distributed data processing system provided in an embodiment of the present invention, the distributed data processing device 30 stores on the IPFS 10 the input data to be processed as well as the map program and reduce program used to perform distributed data processing, and selects at least two operation nodes 20 from all of the computation nodes; then the distributed data processing device 30 can separately control each operation node 20 to download a portion or all of the map program, reduce program and input data from the IPFS 10, and control the operation nodes 20 to use the downloaded map program and reduce program to subject the downloaded input data to mapreduce processing, to obtain at least two result data; then the distributed data processing device 30 can store each obtained result data on the IPFS 10, obtain first storage address information corresponding to each result data, and obtain second storage address information of output data corresponding to the input data according to each item of first storage address information. Since the input data, map program and reduce program are all stored on the IPFS 10, a fault in a portion of the nodes of the IPFS 10 will not affect normal downloading of the input data, map program and reduce program by each operation node 20, hence the distributed data processing procedure will not be unable to proceed normally due to a single-point fault in the IPFS 10; thus, the usability of distributed data processing can be improved.

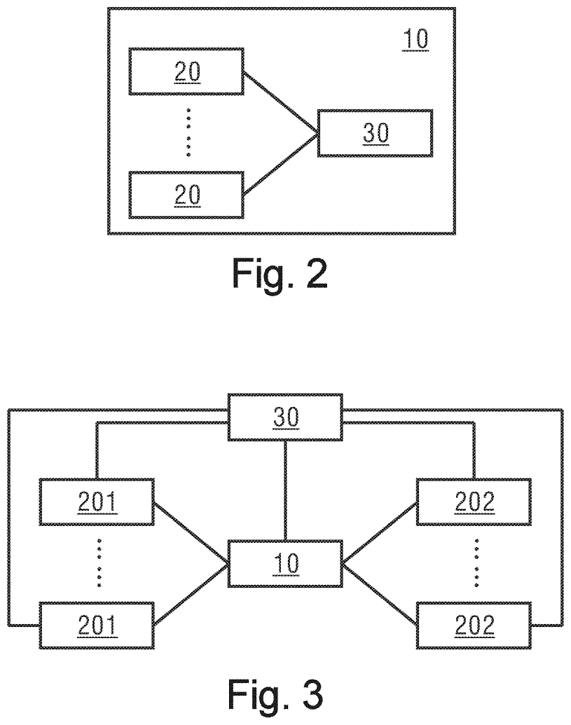

Optionally, based on the distributed data processing system shown in FIG. 1, as shown in FIG. 2, each computation node may be a node of the IPFS 10, i.e. each operation node 20 is a node of the IPFS 10, and at the same time the distributed data processing device 30 may also be deployed on a node of the IPFS 10. It must be explained that the distributed data processing device is not deployed on a node of the IPFS 10 in a fixed manner, but instead is deployed on a corresponding node in the IPFS 10 according to a data processing initiating side; for example, a user initiates a distributed data processing task via a node of the IPFS 10, and then the distributed data processing device 30 is deployed on that node.

The distributed data processing device 30 is deployed on different nodes in the IPFS 10, depending on the initiating side of the data processing task, such that the distributed data processing system is a complete distributed architecture. When a particular node of the IPFS 10 develops a fault and is unable to operate normally, then as long as the distributed data processing device 30 is not deployed on that faulty node, the distributed data processing procedure can proceed normally, and thus the usability of distributed data processing can be further improved.

Optionally, based on the distributed data processing system shown in FIG. 1, as shown in FIG. 3, the at least two operation nodes 20 consist of at least two map nodes 201 and at least two reduce nodes 202; the map node 201 is an operation node 20 that has downloaded the map program, the reduce node 202 is an operation node 20 that has downloaded the reduce program, and the map node 201 and reduce node 202 might be the same operation node 20.

Under the control of the distributed data processing device 30, each map node 201 can subject the downloaded input data to map processing via the downloaded map program to obtain an intermediate result, and store the obtained intermediate result in an internal memory thereof or in the IPFS 10.

Under the control of the distributed data processing device 30, each reduce node 202 can read the intermediate result from the internal memory of the map node 201 or from the IPFS 10, subject the read intermediate result to reduce processing via the downloaded reduce program to obtain result data, and finally store the result data in the IPFS 10.

A distributed data processing method provided in an embodiment of the present invention is described below; unless otherwise stated, the IPFS in the distributed data processing method below may be the abovementioned IPFS 10, the operation node in the distributed data processing method below may be the abovementioned operation node 20, the map node in the distributed data processing method below may be the abovementioned map node 201, and the reduce node in the distributed data processing method below may be the abovementioned reduce node 202.

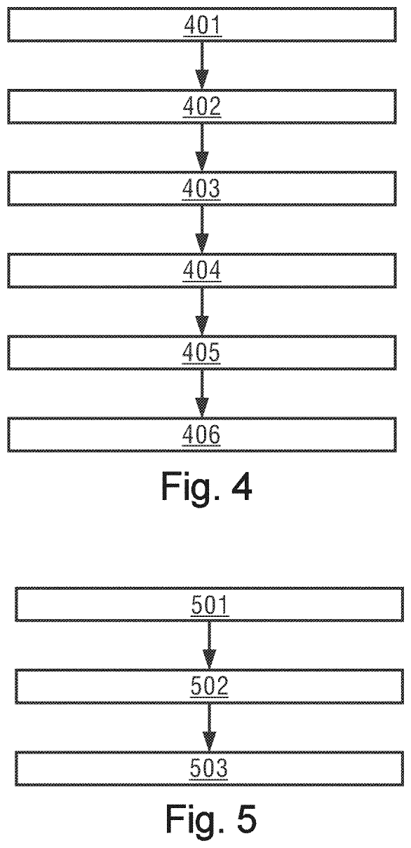

An embodiment of the present invention provides a distributed data processing method, in which input data, a map program and a reduce program are stored on an IPFS, and operation nodes are controlled to download the input data, map program and reduce program from the IPFS to perform distributed data processing; as shown in FIG. 4, the method may specifically comprise the following steps:

step 401: input data to be processed and a corresponding map program and reduce program are stored on an IPFS;

step 402: at least two operation nodes are selected from at least two predetermined computation nodes;

step 403: each operation node is controlled to download at least one of the map program and reduce program from the IPFS, and the operation node that has downloaded the map program is controlled to download the input data from the IPFS;

step 404: the operation nodes are used to subject the input data to mapreduce processing via the map program and reduce program, to obtain at least two result data corresponding to the input data;

step 405: the at least two result data acquired are stored in the IPFS, and first storage address information corresponding to each result data is separately obtained;

step 406: second storage address information of output data corresponding to the input data is obtained according to the at least two items of first storage address information acquired.

In the distributed data processing method provided in an embodiment of the present invention, the input data to be processed as well as the map program and reduce program used to process the input data are stored on the IPFS, and at least two operation nodes are selected from at least two predetermined computation nodes; then the operation nodes are controlled to download a portion or all of the map program, reduce program and input data from the IPFS; then the operation nodes are controlled to subject the input data to mapreduce processing via the map program and reduce program to obtain at least two result data; then each obtained result data is stored on the IPFS, and first storage address information corresponding to each result data is obtained; and then second storage address information of output data corresponding to the input data is obtained according to each item of first storage address information. Since the input data, map program and reduce program are all stored on the IPFS, based on the point-to-point data transfer protocol of the IPFS, a fault in a particular node in the IPFS will not result in the operation nodes being unable to download the input data, map program and reduce program to perform distributed data processing, thus the usability of distributed data processing can be improved.

In an embodiment of the present invention, since the IPFS is based on content addressing, the first storage address information may be a Hash value generated for the stored result data by the IPFS, and correspondingly, the second storage address information may be a Hash value that corresponds to an output result and that is generated by integrating all of the first storage address information. Specifically, once all of the result data has been stored on the IPFS, the IPFS will separately generate a Hash value corresponding to each result data, and by integrating the Hash values of all of the result data, a Hash value corresponding to output data can be obtained; via the Hash value corresponding to the output data, the user can read all of the result data from the IPFS and perform combination, and a combination result is output data resulting from distributed data processing of the input data.

It must be explained that when the input data and the corresponding map program and reduce program are stored on the IPFS in step 401, the input data and the corresponding map program and reduce program may be stored on a particular node of the IPFS, or the input data and the corresponding map program and reduce program may be stored on the IPFS in a distributed storage fashion. Correspondingly, when the operation nodes are controlled to download the input data, map program and reduce program from the IPFS in step 403, the input data, map program and reduce program may be downloaded from a particular node of the IPFS, or the input data, map program and reduce program stored in the distributed storage fashion may be downloaded from the IPFS. Furthermore, since the operation nodes may be nodes of the IPFS, if the input data, map program and reduce program to be downloaded by the operation nodes are stored on storage devices which they themselves comprise, then the downloading of the input data, map program and reduce program by the operation nodes as described in the abovementioned embodiments and subsequent embodiments means reading the input data, map program and reduce program from their own storage devices.

Optionally, based on the distributed data processing method shown in FIG. 4, step 402 of selecting at least two operation nodes from at least two predetermined computation nodes may specifically be implemented by the following sub-steps, as shown in FIG. 5:

step 501: acquiring a node identifier of each of the at least two predetermined computation nodes;

step 502: separately subjecting the node identifier of each computation node to a Hash operation according to a preset Hash function, to obtain a node Hash value corresponding to each computation node;

step 503: selecting as operation nodes at least two of the at least two computation nodes according to the node Hash value corresponding to each computation node.

The node identifier is used to identify the identity of the computation node; different computation nodes have different node identifiers, and by subjecting the node identifiers to a Hash operation to obtain node Hash values, it is ensured that different computation nodes have different corresponding node Hash values, thus it is possible to select the operation nodes from the computation nodes according to the node Hash values. Furthermore, the selection of operation nodes from the computation nodes according to the node Hash values can ensure the randomness of operation node selection, i.e. the operation nodes can be selected randomly from the computation nodes, and it is possible to avoid input data theft or tampering caused by malicious hijacking of operation nodes, and thereby possible to improve the security of distributed data processing.

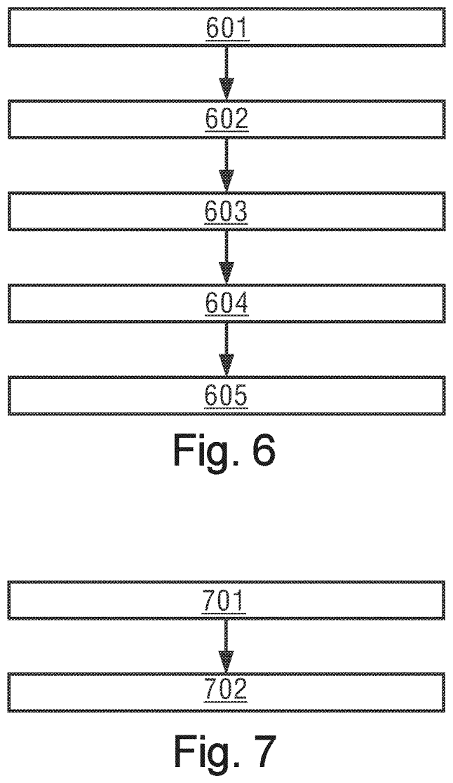

Based on the operation node selection method shown in FIG. 5, step 503 of selecting operation nodes from the computation nodes according to the node Hash value corresponding to the computation nodes may specifically be implemented by the following sub-steps, as shown in FIG. 6:

step 601: subjecting the node Hash values corresponding to the computation nodes to annular sequencing, such that the node Hash values increase progressively clockwise or anticlockwise from the smallest node Hash value;

step 602: subjecting the input data to a Hash operation according to a preset Hash function, to obtain a corresponding positioning Hash value;

step 603: determining the position of the positioning Hash value in the annularly sequenced node Hash values;

step 604: determining K node Hash values after the positioning Hash value in a set direction to be target node Hash values, wherein the set direction is the clockwise direction or anticlockwise direction, and K is a predetermined number of required operation nodes;

step 605: determining the computation nodes corresponding to the K target node Hash values to be operation nodes.

After subjecting the node identifiers of the computation nodes to a Hash operation via a Hash function to obtain the node Hash values, the same Hash function is used to subject the input data to Hash conversion to obtain the positioning Hash value, and after determining the position of the positioning Hash value in the annularly sequenced node Hash values, the computation nodes corresponding to K node Hash values after the positioning Hash value in the clockwise direction or anticlockwise direction are determined to be the operation nodes. Since different input data have different corresponding positioning Hash values, different operation nodes can be determined for different input data, avoiding the security risk associated with malicious hijacking of operation nodes when fixed operation nodes are used to process the input data.

For example, 100 computation nodes are predetermined, and once the node Hash values corresponding to the 100 computation nodes have been annularly sequenced so as to increase progressively clockwise, the 100 node Hash values are sequentially node Hash values 1 to 100 in order from small to large. Based on Hash value size, a positioning Hash value 1 corresponding to input data 1 is located between node Hash values 5 and 6, thus computation nodes 6 to 25 corresponding to node Hash values 6 to 25 are determined to be 20 required operation nodes. Here, the requirement for 20 operation nodes is predetermined.

Optionally, based on the distributed data processing method shown in FIG. 4, controlling the operation node that has downloaded the map program to download the input data from the IPFS in step 403 may specifically be implemented in the following manner:

for each operation node that has downloaded the map program, the operation node is controlled to download all or a portion of the data included in the input data from the IPFS according to the type of the map program downloaded by the operation node.

Depending on the type of the map program, for any element included in the input data, a first type of map program can accomplish all map processing for the element, and a second type of map program can only accomplish a portion of map processing for the element. For example, a first map program is used to count the number of occurrences of the word “map” in a file, and when the number of occurrences of the word “map” in the file is counted via this map program, this map program belongs to the first type of map program; a second map program is used to count the number of occurrences of the word “reduce” in the file, and when the total number of occurrences of the word “map” and the word “reduce” in the file is counted via this map program, the first map program is also needed to count the number of occurrences of the word “map” in the file, in which case the second map program belongs to the second type of map program. For the first type of map program, since all of the operation nodes that have downloaded the map program perform the same map processing, the input data can be split into multiple parts to be subjected to map processing by all of the operation nodes, i.e. the operation node that has downloaded the map program is controlled to download a portion of the data included in the input data from the IPFS. For the second type of map program, since multiple map programs are needed in order to complete the map processing task, each operation node that has downloaded the map program might need to subject all of the data included in the input data to map processing, thus the operation node that has downloaded the map program may be controlled to download all of the data included in the input data from the IPFS.

Controlling the operation node that has downloaded the map program to download the input data from the IPFS according to the type of the map program allows the operation node to download only the portion of input data that it needs to subject to map processing; this can not only reduce the pressure on the IPFS due to data reading, but can also shorten the time needed for the operation node to download the input data, thus increasing the efficiency of distributed data processing.

It must be explained that regardless of the type of map program downloaded by the operation node, each operation node that has downloaded the map program can download all of the data included in the input data from the IPFS. Furthermore, the same operation node can download one of the map program and the reduce program, or download the map program and reduce program at the same time; when an operation node only downloads the map program, the operation node is a map node; when the operation node only downloads the reduce program, the operation node is a reduce node; and when an operation node downloads both the map program and the reduce program, the operation node serves as both a map node and a reduce node.

Optionally, based on the distributed data processing method shown in FIG. 4, after at least two operation nodes have been selected from at least two predetermined computation nodes in step 402, the selected operation nodes can be allocated as a map node or a reduce node; this can specifically be implemented in the following manner:

at least two of the selected at least two operation nodes are selected as map nodes, and at least two of the selected at least two operation nodes are selected as reduce nodes. When selecting the map nodes and reduce nodes from the operation nodes, the numbers of map nodes and reduce nodes can be determined according to a preset configuration parameter, or the numbers of map nodes and reduce nodes can be determined according to the quantity of input data.

Correspondingly, step 403, in which each operation node is controlled to download at least one of the map program and reduce program from the IPFS, and the operation node that has downloaded the map program is controlled to download the input data from the IPFS, may specifically be implemented in the following manner:

each map node is controlled to download the map program and input data from the IPFS, and each reduce node is controlled to download the reduce program from the IPFS.

After selecting at least two operation nodes from the computation nodes, according to a first method, based on a preset configuration parameter, corresponding numbers of map nodes and reduce nodes can be selected from the at least two operation nodes; according to a second method, based on the data quantity of input data, corresponding numbers of map nodes and reduce nodes can be automatically selected. In the first method, the user sets the configuration parameter, and the number of map nodes needed and the number of reduce nodes needed are defined via the configuration parameter; for example, after selecting 20 operation nodes, then based on the configuration parameter defined by the user, 15 operation nodes are selected as map nodes from the 20 operation nodes, and 8 operation nodes are selected as reduce nodes from the 20 operation nodes, wherein each operation node at least serves as a map node or reduce node. In the second method, based on the data quantity of input data and the number of operation nodes, the number of map nodes and the number of reduce nodes are determined automatically; for example, after selecting 20 operation nodes, if the data quantity of input data is large, then all 20 operation nodes are used as map nodes, while 10 operation nodes are selected as reduce nodes from the 20 operation nodes; if the data quantity of input data is small, operation nodes are selected as map nodes from the 20 operation nodes, and the 5 operation nodes that were not selected are used as reduce nodes.

After selecting the operation nodes, the number of map nodes and the number of reduce nodes can be determined according to the preset configuration parameter or the data quantity of input data, thus enabling the user to define the numbers of map nodes and reduce nodes him/herself or enabling automatic determination of the numbers of map nodes and reduce nodes, so as to meet the individual needs of different users; it is thereby possible to increase the level of user satisfaction when using the distributed data processing method.

Optionally, based on the selection of map nodes and reduce nodes from the operation nodes in the embodiment above, step 404, in which the operation nodes are used to subject the input data to mapreduce processing via the map program and reduce program, to obtain at least two result data corresponding to the input data, may specifically be implemented by the following sub-steps, as shown in FIG. 7:

step 701: each map node is used separately to subject the downloaded input data to map processing via the downloaded map program, and an intermediate result obtained through map processing by the map node is stored in an internal memory of the map node or in the IPFS;

step 702: each reduce node is used separately to read at least one intermediate result from the internal memory of at least one map node or from the IPFS, and the read intermediate result is subjected to reduce processing via the downloaded reduce program, to obtain result data corresponding to each reduce node.

After controlling each map node to subject the downloaded input data to map processing via the downloaded map program to obtain the intermediate result, the intermediate result can be stored in the internal memory of the map node or in the IPFS according to the data quantity of the intermediate result. Specifically, when the data quantity of the intermediate result is small, the intermediate result obtained through map processing by the map node is stored in the internal memory of the map node, and the reduce node can read the intermediate result from the internal memory of the map node directly, thus saving the time needed to transfer the intermediate result, and helping to increase the efficiency of distributed data processing; when the data quantity of the intermediate result is large, the intermediate result obtained through map processing by the map node is stored in the IPFS, and the reduce node can read the intermediate result from the IPFS, thus ensuring that the map node has enough internal memory for normal operation.

Optionally, based on the method shown in FIG. 7 for subjecting the input data to mapreduce processing, storing the at least two acquired result data in the IPFS in step 405 may specifically be implemented in the following manner:

for each reduce node, the reduce node is controlled to store the result data obtained through reduce processing in a local disk of the reduce node, and then uploads the result data stored in the local disk to the IPFS via a data transfer program pre-deployed on the reduce node.

To solve the problem of the reduce node being unable to write data into the IPFS directly, a data transfer program is deployed on the reduce node in advance; after obtaining the result data, the reduce node first stores the acquired result data on the local disk, and then uploads the result data stored in the local disk to the IPFS via the data transfer program for storage, making it convenient for the user to read the result of distributed data processing from the IPFS.

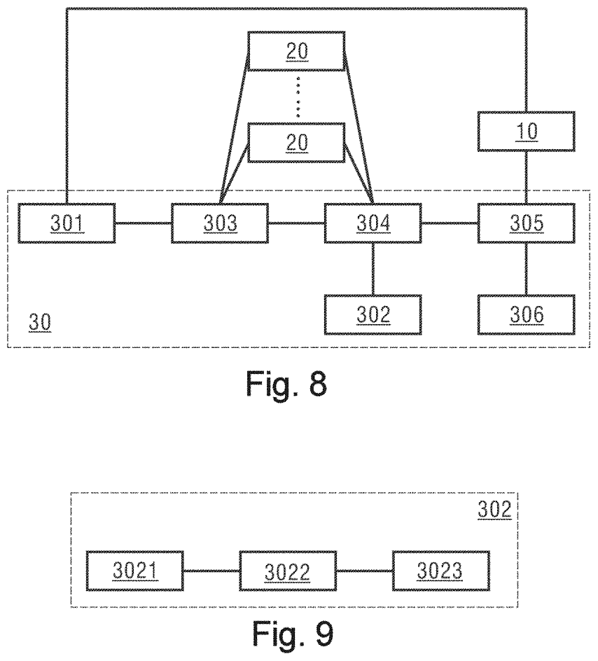

As shown in FIG. 8, an embodiment of the present invention provides a distributed data processing device 30, comprising:

a data uploading module 301, for storing, on an InterPlanetary File System IPFS 10, input data to be processed and a corresponding map program and reduce program;

a node selection module 302, for selecting at least two operation nodes 20 from at least two predetermined computation nodes;

a data distribution module 303, for controlling each operation node 20 to download from the IPFS 10 at least one of the map program and reduce program stored by the data uploading module 301, and controlling the operation node 20 that has downloaded the map program to download from the IPFS 10 the input data stored by the data uploading module 301;

a processing control module 304, for using the at least two operation nodes 20 selected by the node selection module 302 to subject the input data to mapreduce processing via the map program and reduce program downloaded under the control of the data distribution module 303, to obtain at least two result data corresponding to the input data;

a data storage module 305, for storing in the IPFS 10 the at least two result data obtained by the processing control module 304, and separately obtaining first storage address information corresponding to each result data;

a data integration module 306, for obtaining second storage address information of output data corresponding to the input data according to the at least two items of first storage address information acquired by the data storage module 305.

In an embodiment of the present invention, the data uploading module 301 may be used to perform step 401 in the method embodiment above, the node selection module 302 may be used to perform step 402 in the method embodiment above, the data distribution module 303 may be used to perform step 403 in the method embodiment above, the processing control module 304 may be used to perform step 404 in the method embodiment above, the data storage module 305 may be used to perform step 405 in the method embodiment above, and the data integration module 306 may be used to perform step 406 in the method embodiment above.

Optionally, based on the distributed data processing device 30 shown in FIG. 8, the node selection module 302 comprises, as shown in FIG. 9:

a node identifier acquisition unit 3021, for acquiring a node identifier of each of the at least two predetermined computation nodes;

a Hash operation unit 3022, for separately subjecting the node identifier corresponding to each computation node and acquired by the node identifier acquisition unit 3021 to a Hash operation according to a preset Hash function, to obtain a corresponding node Hash value;

a node selection unit 3023, for selecting as operation nodes 20 at least two of the at least two computation nodes according to the node Hash value corresponding to each computation node and obtained by the Hash operation unit 3022.

In an embodiment of the present invention, the node identifier acquisition unit 3021 may be used to perform step 501 in the method embodiment above, the Hash operation unit 3022 may be used to perform step 502 in the method embodiment above, and the node selection unit 3023 may be used to perform step 503 and steps 601 to 605 in the method embodiments above.

Optionally, based on the distributed data processing device shown in FIG. 8, the data distribution module 303 is configured, for each operation node 20, to control the operation node 20 to download all or a portion of the data included in the input data from the IPFS 10 according to the type of the map program downloaded by the operation node 20.

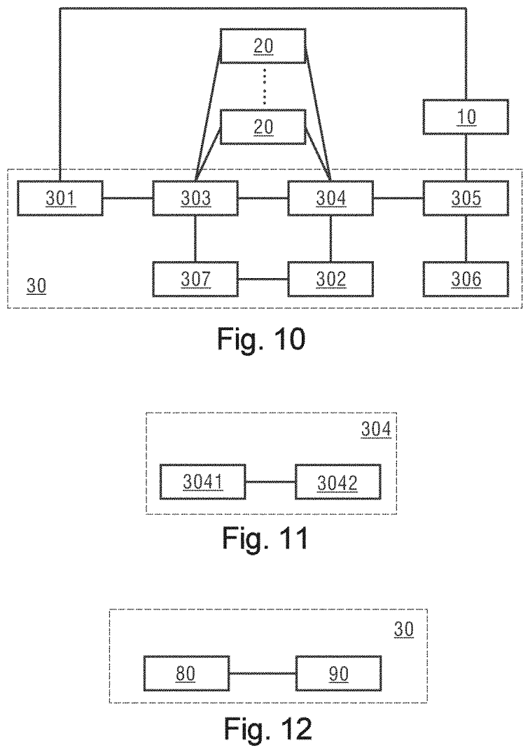

Optionally, based on the distributed data processing device shown in FIG. 8, the distributed data processing device may further comprise, as shown in FIG. 10:

a node allocation module 307;

the node allocation module 307 is configured to select as map nodes 201 at least two of the at least two operation nodes 20 selected by the node selection module 302, and select as a reduce node 202 at least one of the at least two operation nodes 20 selected by the node selection module 302, wherein the numbers of the map nodes 201 and the reduce node 202 are determined according to a preset configuration parameter or determined according to the data quantity of the input data;

the data distribution module 303 is configured to control each map node 201 selected by the node allocation module 307 to download the map program and the input data from the IPFS 10, and control each reduce node 202 selected by the node allocation module 307 to download the reduce program from the IPFS 10.

Optionally, based on the distributed data processing device shown in FIG. 10, the processing control module 304 comprises, as shown in FIG. 11:

a map control unit 3041, for using each map node 201 separately to subject the downloaded input data to map processing via the downloaded map program, and storing an intermediate result obtained through map processing by the map node 201 in an internal memory of the map node 201 or in the IPFS 10;

a reduce control unit 3042, for using each reduce node 202 separately to read at least one intermediate result from the internal memory of at least one map node 201 or from the IPFS 10, and subjecting the read intermediate result to reduce processing via the downloaded reduce program, to obtain result data corresponding to the reduce node 202.

In an embodiment of the present invention, the map control unit 3041 may be used to perform step 701 in the method embodiment above, and the reduce control unit 3042 may be used to perform step 702 in the method embodiment above.

Optionally, based on the processing control module 304 shown in FIG. 11, the data storage module 305 is configured, for each reduce node 202, to control the reduce node 202 to store the result data obtained through reduce processing in a local disk of the reduce node 202, and upload the result data stored in the local disk to the IPFS 10 via a data transfer program pre-deployed on the reduce node 202.

As shown in FIG. 12, an embodiment of the present invention provides a distributed data processing device 30, comprising:

at least one memory 80 and at least one processor 90;

the at least one memory 80 being configured to store a machine readable program;

the at least one processor 90 being configured to call the machine readable program stored in the at least one memory 80, to perform the steps in the method embodiments above.

The present invention also provides a machine-readable medium which stores instructions for causing a machine to execute the distributed data processing method described herein. Specifically, a system or device equipped with a storage medium may be provided, wherein software program code realizing the functions of any one of the above embodiments is stored on the storage medium, and a computer (or CPU or MPU) of the system or device reads and executes the program code stored in the storage medium.

In this case, the program code read from the storage medium is itself capable of realizing the functions of any one of the above embodiments, hence the program code and the storage medium storing the program code form part of the present invention.

Embodiments of storage media used to provide program code include floppy disks, hard disks, magneto-optical disks, optical disks (eg. CD-ROM, CD-R, CD-RW, DVD-ROM, DVD-RAM, DVD-RW, DVD+RW), magnetic tape, non-volatile memory cards and ROM. Optionally, a communication network may download program code from a server computer.

In addition, it should be clear that an operating system operating on a computer, etc. can be caused to complete some or all of the actual operations via instructions based on program code, so as to realize the functions of any one of the above embodiments.

In addition, it will be understood that program code read out from the storage medium is written into a memory installed in an expansion board inserted in the computer, or written into a memory installed in an expansion unit connected to the computer, and thereafter instructions based on program code cause a CPU, etc. installed on the expansion board or expansion unit to execute some or all of the actual operations, so as to realize the functions of any one of the above embodiments.

It must be explained that not all of the steps and modules in the flows and system structure diagrams above are necessary; certain steps or modules may be omitted according to actual requirements. The order in which steps are executed is not fixed, but may be adjusted as required. The system structures described in the embodiments above may be physical structures, or logical structures, i.e. some modules might be realized by the same physical entity, or some modules might be realized by multiple physical entities, or realized jointly by certain components in multiple independent devices.

In the embodiments above, a hardware unit may be realized in a mechanical or an electrical manner. For example, a hardware unit may comprise a permanent dedicated circuit or logic (e.g. a special processor, FPGA or ASIC) to complete a corresponding operation. A hardware unit may also comprise programmable logic or circuitry (e.g. a universal processor or another programmable processor), and may be configured temporarily by software to complete a corresponding operation. Particular embodiments (mechanical, or dedicated permanent circuitry, or temporarily configured circuitry) may be determined on the basis of considerations of cost and time.

The present invention has been displayed and explained in detail above via the accompanying drawings and preferred embodiments, but the present invention is not limited to these disclosed embodiments. Based on the multiple embodiments described above, those skilled in the art will know that further embodiments of the present invention, also falling within the scope of protection of the present invention, could be obtained by combining code checking means in different embodiments above.

1. A distributed data processing method, comprising:
storing, on an InterPlanetary File System IPFS, input data to be processed and a corresponding map program and a reduce program;
selecting at least two operation nodes from at least two computation nodes;
controlling each operation node, of the at least two operation nodes, to download from the IPFS at least one of the map program and the reduce program, and controlling each operation node that has downloaded the map program, to download the input data from the IPFS;
using the at least two operation nodes to subject the input data to mapreduce processing via the map program and the reduce program, to obtain at least two result data corresponding to the input data;
storing the at least two result data in the IPFS, and separately obtaining first storage address information corresponding to each result data of the obtain at least two result data;
obtaining second storage address information of output data corresponding to the input data according to at least two items of first storage address information corresponding to the at least two result data.

2. The method of claim 1, wherein the selecting of the at least two operation nodes comprises:
acquiring a node identifier of each respective computation node of the at least two computation nodes;
separately subjecting the node identifier of each respective computation node, of the at least two computation nodes, to a Hash operation according to a Hash function, to obtain a corresponding node Hash value;
selecting as the operation nodes at least two of the at least two computation nodes according to the node Hash value corresponding to each computation node of the at least two computation nodes.

3. The method of claim 1, wherein the controlling of each the operation node comprises:
for each respective operation node, controlling the respective operation node to download all or a portion of the data included in the input data from the IPFS according to a type of the map program downloaded by the respective operation node.

4. The method of claim 1, wherein
after the selecting of the at least two operation nodes, the method further comprises:
selecting as map nodes, at least two operation nodes of the at least two operation nodes, and selecting as a reduce node at least one operation node of the at least two operation nodes, wherein numbers of the map nodes and the reduce node are determined according to a configuration parameter or determined according to a data quantity of the input data;
wherein the step controlling each the operation node, comprises:
controlling each map node to download the map program and the input data from the IPFS, and controlling each educe node to download the reduce program from the IPFS.

5. The method of claim 4, wherein the using of the at least two operation nodes, comprises:
using each the map node separately to subject the downloaded input data to map processing via the downloaded map program, and storing an intermediate result obtained through map processing by the map node in an internal memory of the map node or in the IPFS; and
using each reduce node separately to read at least one the intermediate result from the internal memory of at least one map node or from the IPFS, and subjecting the read intermediate result to reduce processing via the downloaded reduce program, to obtain the result data corresponding to the reduce node.

6. The method of claim 5, wherein the storing of the at least two result data in the IPFS comprises:
for each respective reduce node, controlling the respective reduce node to store the result data obtained through reduce processing in a local disk of the respective reduce node, and upload the result data stored in the local disk to the IPFS via data transfer program pre-deployed on the reduce node.

7. A distributed data processing device, comprising:
at least one memory,
configured to store a machine readable program; and
at least one processor, configured to call the machine readable program, to execute at least:
storing, on an InterPlanetary File System (IPFS), input data to be processed and a corresponding map program and reduce program;
selecting at least two operation nodes from at least two computation nodes;
controlling each operation node, of the at least two operation nodes, to download from the IPFS at least one of the map program and the reduce program, and controlling each operation node that has downloaded the map program to download the input data from the IPFS;
using the at least two operation nodes to subject the input data to mapreduce processing via the map program and the reduce program, to obtain at least two result data corresponding to the input data;
storing the at least two result data in the IPFS, and separately obtaining first storage address information corresponding to each said-result data of the at least two result data; and
obtaining second storage address information of output data corresponding to the input data according to at least two items of first storage address information corresponding to the at least two result data.

8. The device of claim 7, wherein the at least one processor, when calling the machine readable program, and selecting at least two operation nodes from at least two computation nodes, executes at least:
acquiring a node identifier of each respective computation node of the at least two computation nodes;
separately subjecting the node identifier of each respective computation node to a Hash operation according to a Hash function, to obtain a corresponding node Hash value;
selecting as the operation nodes, at least two of the at least two computation nodes according to a node Hash value corresponding to each respective computation node of the at least two computation nodes.

9. The device of claim 7, herein the at least one processor, when calling the machine readable program, and controlling the operation node that has downloaded the map program to download the input data from the IPFS, executes at least:
for each respective operation node, controlling the respective operation node to download all or a portion of the data included in the input data from the IPFS according to a type of the map program downloaded by the respective operation node.

10. The device of claim 7, wherein the at least one processor, after calling the machine readable program, and when selecting the at least two operation nodes from at least two computation nodes, further executes at least:
selecting as map nodes, at least two operation nodes of the at least two operation nodes, and
selecting as a reduce node at least one operation node of the at least two operation nodes, wherein numbers of the map nodes and the reduce node are determined according to a configuration parameter or determined according to a data quantity of the input data;
and wherein the at least one processor, when calling the machine readable program, and controlling each the operation node to download from the IPFS executes at least:
controlling each map node to download the map program and the input data from the IPFS, and controlling each reduce node to download the reduce program from the IPFS.

11. The device as of claim 10, wherein the at least one processor, when calling the machine readable program, and when using the at least two operation nodes to subject the input data to mapreduce processing executes at least:
using each map node separately, to subject the downloaded input data to map processing via the downloaded map program, and storing an intermediate result obtained through map processing by the map node in an internal memory of the map node or in the IPFS; and
using each reduce node, separately, to read at least one the intermediate result from the internal memory of at least one the map node or from the IPFS, and subjecting the read intermediate result to reduce processing via the downloaded reduce program, to obtain the result data corresponding to the reduce node.

12. The device of claim 11, wherein the at least one processor, when calling the machine readable program, and when storing the at least two result data in the IPFS, executes pat least:
for each reduce node, controlling the reduce node to store the result data obtained through reduce processing in a local disk of the reduce node, and upload the result data stored in the local disk to the IPFS via a data transfer program pre-deployed on the reduce node.

13. A non-transitory machine readable medium, storing a computer instruction which, when executed by a processor, causes the processor to execute at least:
storing, on an InterPlanetary File System IPFS, input data to be processed and a corresponding map program and reduce program;
selecting at least two operation nodes from at least two computation nodes;
controlling each operation node, of the at least two operation nodes, to wane download from the IPFS at least one of the map program and the reduce program, and controlling the operation node that has downloaded the map program to download the input data from the IPFS;
using the at least two operation nodes to subject the input data to mapreduce processing via the map program and the reduce program, to obtain at least two result data corresponding to the input data;
storing the at least two result data in the IPFS, and separately obtaining first storage address information corresponding to each result data of the at least two result data;
obtaining second storage address information of output data corresponding to the input data according to at least two items of first storage address information corresponding to the at least two result data.

14. The non-transitory machine readable medium as of claim 13, wherein the computer instruction, when executed by the processor to select the at least two operation nodes from at least two computation nodes, causes the processor to execute at least:
acquiring a node identifier of each respective computation node of the at least two computation nodes;
separately subjecting the node identifier of each respective computation node to a Hash operation according to a function, to obtain a corresponding node Hash value;
selecting as the operation nodes, at least two computation nodes of the at least two computation nodes according to the node Hash value corresponding to each respective computation node of the computation nodes.

15. The non-transitory machine readable medium of claim 13, wherein the computer instruction, when executed by the processor to control the operation node that has downloaded the map program to download the input data from the IPFS, causes the processor to execute pat least:
for each the operation node, controlling the operation node to download all or a portion of the data included in the input data from the IPFS according to a type of the map program downloaded by the operation node.

16. The method of claim 2, wherein the controlling of each operation node comprises:
for each respective operation node, controlling the respective operation node to download all or a portion of the data included in the input data from the IPFS according to a type of the map program downloaded by the respective operation node.

17. The method of claim 2, wherein
after the selecting of the at least two operation nodes, the method further comprises:
selecting as map nodes, at least two operation nodes of the at least two operation nodes, and selecting as a reduce node at least one operation node of the at least two operation nodes, wherein numbers of the map nodes and the reduce node are determined according to a configuration parameter or determined according to a data quantity of the input data;
wherein the controlling each the operation node, comprises:
controlling each map node to download the map program and the input data from the IPFS, and controlling each reduce node to download the reduce program from the IPFS.

18. The device of claim 8, wherein the at least one processor, when calling the machine readable program, and controlling the operation node that has downloaded the map program to download the input data from the IPFS, executes at least:
for each respective operation node, controlling the respective operation node to download all or a portion of the data included in the input data from the IPFS according to a type of the map program downloaded by the respective operation node.

19. The device of claim 8, wherein the at least one processor, after calling the machine readable program, and when selecting the at least two operation nodes from at least two computation nodes, further executes at least:
selecting as map nodes, at least two operation nodes of the at least two operation nodes, and
selecting as a reduce node at least one operation node of the at least two operation nodes, wherein numbers of the map nodes and the reduce node are determined according to a configuration parameter or determined according to a data quantity of the input data;
and wherein the at least one processor, when calling the machine readable program, and controlling each the operation node to download from the IPFS, executes at least:
controlling each map node to download the map program and the input data from the IPFS, and controlling each reduce node to download the reduce program from the IPFS.

20. The non-transitory machine readable medium of claim 14, wherein the computer instruction, when executed by the processor to control the operation node that has downloaded the map program to download the input data from the IPFS, causes the processor to execute at least:
for each the operation node, controlling the operation node to download all or a portion of the data included in the input data from the IPFS according to a type of the map program downloaded by the operation node.
